(19) United States
(12) Patent Application Publication
(10) Pub. No.: US 2025/0183734 A1
(43) Pub. Date: Jun. 5, 2025

(54) APPARATUS AND METHOD FOR CONTROLLING CHARGING FOR A WIRELESS CHARGING SYSTEM

(71) Applicants: HYUNDAI MOTOR COMPANY, Seoul (KR); KIA CORPORATION, Seoul (KR)

(72) Inventors: Sung Yeal Park, Gwangju (KR); Young Jae Lee, Uiwang-si (KR)

(73) Assignees: HYUNDAI MOTOR COMPANY, Seoul (KR); KIA CORPORATION, Seoul (KR)

(21) Appl. No.: 18/637,988

(22) Filed: Apr. 17, 2024

(30) Foreign Application Priority Data
Dec. 4, 2023 (KR) 10-2023-0173605

(51) Int. Cl. H02J 50/90; B60R 16/03; H02J 7/00; H02J 50/12

(52) U.S. Cl. CPC H02J 50/90; B60R 16/03; H02J 7/0013; H02J 7/0042; H02J 7/0048; H02J 50/12

(57) ABSTRACT

An apparatus and a method for controlling charging for a wireless charging system are disclosed. The apparatus includes a transfer device for moving a wireless power transmitter mounted on a roof of a vehicle in front, rear, left, and right directions. The apparatus detects the location of a portable terminal inside the vehicle and adjusts the location of the wireless power transmitter based on the location of the portable terminal. Thus, the charging efficiency of the wireless charging system mounted on the vehicle may be improved.

### CROSS-REFERENCE TO RELATED APPLICATION

This application claims the benefit of and priority to Korean Patent Application No. 10-2023-0173605, filed in the Korean Intellectual Property Office on Dec. 4, 2023, the entire contents of which are incorporated herein by reference.

### TECHNICAL FIELD

The present disclosure relates to a technology that may improve the charging efficiency of a wireless charging system by adjusting the position of a wireless power transmitter mounted on the roof of a vehicle based on the position of a portable terminal when the portable terminal is charged in a vehicle.

### BACKGROUND

Generally, schemes for wirelessly charging portable terminals, such as mobile phones, personal digital assistants (PDAs), MP3 players, digital multimedia broadcasting (DMB), and portable music players (PMPs), include magnetic induction and magnetic resonance schemes.

In the magnetic induction scheme, a magnetic field is generated by flowing current in a primary coil provided in a wireless power transmitter. The magnetic field causes an induced current to be generated in a secondary coil provided in the battery of a portable terminal. Thus, the battery is charged using the induced current. According to the magnetic induction scheme, it is possible to enable wireless charging at a distance of several mm to several cm.

In the magnetic resonance scheme, energy is transmitted when the resonance frequencies of the resonance coil mounted on a wireless power transmitter and the resonance coil mounted on the battery match. The energy is absorbed into electromagnetic fields when the resonance frequencies of the resonance coil mounted on a wireless power transmitter and the resonance coil mounted on the battery do not match. Thus, wireless charging is possible at a distance of several meters.

In order to maximize charging efficiency, whether by magnetic induction or magnetic resonance, alignment between the coil of a power transmitter and the coil of a power receiver is essential, so the user must mount the portable terminal at a specified location on a wireless charging pad.

Because a conventional magnetic resonance scheme-based wireless charging system is implemented without considering the vehicle environment, when a portable terminal is applied to a vehicle, the movement of the portable terminal due to the shaking of the vehicle causes the portable terminal to deviate from the optimal position of a wireless power transmitter. Thus, the charging efficiency of the wireless charging system decreases. Such a low charging efficiency causes user dissatisfaction and further reduces the marketability of the vehicle.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides an apparatus for controlling charging for a wireless charging system that includes a transfer device for moving a wireless power transmitter mounted on a roof of a vehicle in front, rear, left, and right directions. The apparatus detects the location of a portable terminal inside the vehicle and adjusts the location of the wireless power transmitter based on the location of the portable terminal in order to improve the charging efficiency of the wireless charging system mounted on the vehicle. The present disclosure also provides a method thereof.

Another aspect of the present disclosure provides an apparatus for controlling charging for a wireless charging system that includes a transfer device for moving a wireless power transmitter mounted on a roof of a vehicle in front, rear, left, and right directions. The apparatus detects the location of a portable terminal inside the vehicle. The apparatus adjusts the location of the wireless power transmitter to be located on a vertical line with the portable terminal in order to improve the charging efficiency of the wireless charging system mounted on the vehicle. The present disclosure also provides a method thereof.

Still another aspect of the present disclosure provides an apparatus for controlling charging for a wireless charging system that includes a transfer device for moving a wireless power transmitter mounted on a roof of a vehicle in front, rear, left, and right directions. The apparatus detects the location of the portable terminal inside the vehicle based on an ultra-wideband (UWB) communication scheme. The apparatus adjusts the location of the wireless power transmitter based on the location of the portable terminal in order to improve the charging efficiency of the wireless charging system mounted on the vehicle. The present disclosure also provides a method thereof.

Still another aspect of the present disclosure provides an apparatus for controlling charging for a wireless charging system that includes a transfer device for moving a wireless power transmitter mounted on a roof of a vehicle in front, rear, left, and right directions. The apparatus detects locations of a plurality of portable terminals, determines a portable terminal with a lowest remaining battery level among the plurality of portable terminals as a target portable terminal. The apparatus adjusts the location of the wireless power transmitter based on the location of the target portable terminal in order to improve the charging efficiency of the wireless charging system mounted on the vehicle. The present disclosure also provides a method thereof.

Still another aspect of the present disclosure provides an apparatus for controlling charging for a wireless charging system that includes a transfer device for moving a wireless power transmitter mounted on a roof of a vehicle in front, rear, left, and right directions. The apparatus periodically detects the location of the portable terminal inside the vehicle. The apparatus periodically adjusts the location of the wireless power transmitter based on the location of the portable terminal in order to improve the charging efficiency of the wireless charging system mounted on the vehicle. The present disclosure also provides a method thereof.

The technical problems to be solved by the present disclosure are not limited to the aforementioned problems. Any other technical problems not mentioned herein should be clearly understood from the following description by those having ordinary skill in the art to which the present disclosure pertains. Also, it may be easily understood that the objects and advantages of the present disclosure may be realized by the units and combinations thereof recited in the claims.

According to an aspect of the present disclosure, an apparatus for controlling charging for a wireless charging system includes a wireless power transmitter mounted on a roof of a vehicle. The apparatus also includes a transfer device that moves the wireless power transmitter in front, rear, left, and right directions. The apparatus also includes a controller that detects a location of a portable terminal inside the vehicle, determines a target location corresponding to the location of the portable terminal, and controls the transfer device to move the wireless power transmitter to the target location.

According to an embodiment, the controller may further determine the target location to allow the wireless power transmitter and the portable terminal to be located on a vertical line.

According to an embodiment, the controller may further detect the location of the portable terminal inside the vehicle based on an ultra-wideband (UWB) communication scheme.

According to an embodiment, the controller may further determine a portable terminal with a lowest remaining battery level among a plurality of portable terminals as a target portable terminal when the plurality of portable terminals is detected inside the vehicle.

According to an embodiment, the controller may further determine a portable terminal with a second lowest battery level as a next target portable terminal when charging of the target portable terminal is completed.

According to an embodiment, the controller may further determine a portable terminal detected first among a plurality of portable terminals as a target portable terminal when the plurality of portable terminals is detected inside the vehicle.

According to an embodiment, the controller may further determine a portable terminal detected second among the plurality of portable terminals as a next target portable terminal when charging of the target portable terminal is completed.

According to an embodiment, the controller may further periodically detect the location of the portable terminal inside the vehicle and re-determine the target location of the wireless power transmitter when a difference between a current location and a previous location of the portable terminal exceeds a threshold.

According to another aspect of the present disclosure, a method of controlling charging for a wireless charging system includes detecting, by a controller, a location of a portable terminal inside a vehicle. The method also includes determining, by the controller, a target location corresponding to the location of the portable terminal. The method also includes moving, by a transfer device, a wireless power transmitter mounted on a roof of the vehicle.

According to an embodiment, determining the target location may include determining, by the controller, the target location to allow the wireless power transmitter and the portable terminal to be located on a vertical line.

According to an embodiment, detecting the location of the portable terminal may include detecting the location of the portable terminal inside the vehicle based on an ultra-wideband (UWB) communication scheme.

According to an embodiment, determining the target location may include determining a portable terminal with a lowest remaining battery level among a plurality of portable terminals as a target portable terminal when the plurality of portable terminals is detected inside the vehicle.

According to an embodiment, determining the target location may further include determining, by the controller, a portable terminal with a second lowest battery level as a next target portable terminal when charging of the target portable terminal is completed.

According to an embodiment, determining the target location may include determining, by the controller, a portable terminal detected first among a plurality of portable terminals as a target portable terminal when the plurality of portable terminals is detected inside the vehicle.

According to an embodiment, determining the target location may further include determining, by the controller, a portable terminal detected second among the plurality of portable terminals as a next target portable terminal when charging of the target portable terminal is completed.

According to an embodiment, determining the target location may further include periodically detecting, by the controller, the location of the portable terminal inside the vehicle. Determining the target location may further include re-determining, by the controller, the target location of the wireless power transmitter when a difference between a current location and a previous location of the portable terminal exceeds a threshold.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram illustrating an example of a wireless charging system to which an embodiment of the present disclosure is applied;

FIG. 2 is a block diagram illustrating a configuration of an apparatus for controlling charging for a wireless charging system according to an embodiment of the present disclosure;

FIG. 3 is a diagram illustrating an example of a process of positioning a wireless power transmitter provided in a wireless charging system to which an embodiment of the present disclosure is applied on a vertical line with a portable terminal;

FIG. 4 is a diagram illustrating an example of the structure of a transfer device provided in an apparatus for controlling charging for a wireless charging system according to an embodiment of the present disclosure;

FIG. 5 is a flowchart illustrating a method of controlling charging for a wireless charging system according to an embodiment of the present disclosure; and

FIG. 6 is a block diagram illustrating a computing system for executing a method of controlling charging for a wireless charging system according to each embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent components are designated by the identical numeral even when the components are displayed on other drawings. Further, in describing the embodiment of the present disclosure, a detailed description of the related known configuration or function has been omitted where it is determined that the detailed description interferes with the understanding of the embodiment of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those having ordinary skill in the art to which the present disclosure pertains. The terms defined in the generally used dictionaries should be construed as having the meanings that coincide with the meanings of the contexts of the related technologies. The terms should not be construed as ideal or excessively formal meanings unless clearly defined in the specification of the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

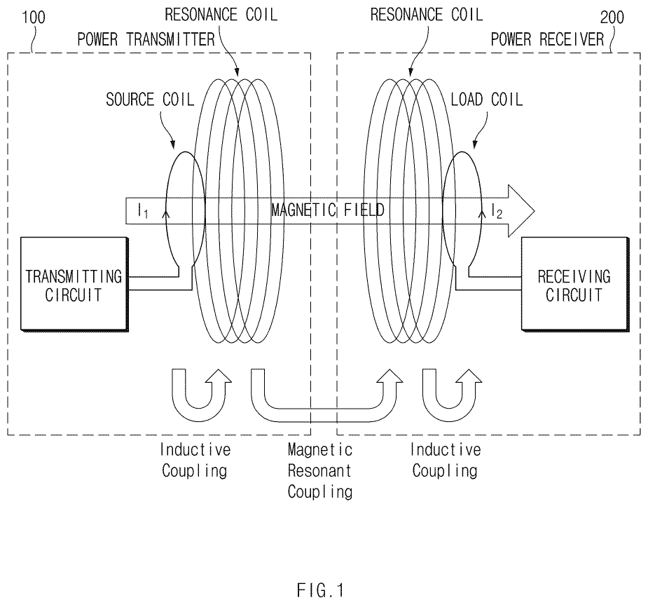

FIG. 1 is a diagram illustrating an example of a wireless charging system to which an embodiment of the present disclosure is applied.

As shown in FIG. 1, a wireless charging system according to an embodiment of the present disclosure may be a magnetic resonant coupling system and may include a power transmitter 100 and a power receiver 200. In this case, the power transmitter 100 may be mounted on a vehicle, and the power receiver 200 may be mounted on a portable terminal.

First, a time-varying current is applied to a source coil, and a magnetic field generated thereby is applied to a resonance coil by ‘inductive coupling’.

Thereafter, ‘magnetic resonant coupling’ occurs between the resonance coil of the power transmitter and the resonance coil of the power receiver having the same resonant frequency, which causes ‘inductive coupling’ in a load coil.

Such a magnetic resonance scheme may transmit power farther than a magnetic induction scheme and may charge portable terminals simultaneously with one power transmitter. In addition, charging is possible even when the centers between the resonance coils of the power transmitter and the resonance coils of the power receiver are not exactly the same, but in this case, charging efficiency may drop sharply.

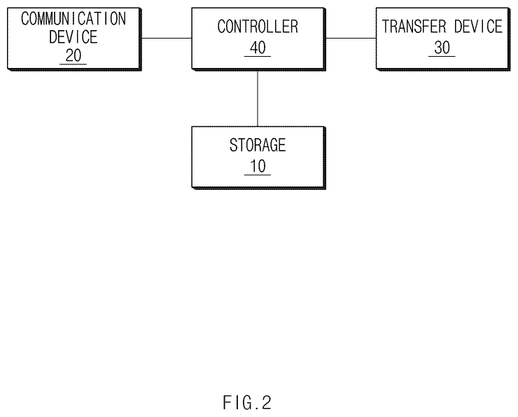

FIG. 2 is a block diagram illustrating a configuration of an apparatus for controlling charging for a wireless charging system according to an embodiment of the present disclosure.

As shown in FIG. 2, an apparatus for controlling charging according to an embodiment of the present disclosure may include storage 10, a communication device 20, a transfer device 30, and a controller 40. In this case, based on a scheme of implementing an apparatus for controlling charging for a wireless charging system according to an embodiment of the present disclosure, components may be combined with each other to be implemented as one, or some components may be omitted.

Regarding each component, the storage 10 may store various logic, algorithms, and programs required in the processes of detecting a location of a portable terminal inside a vehicle and adjusting a location of the wireless power transmitter 100 mounted on a roof of the vehicle.

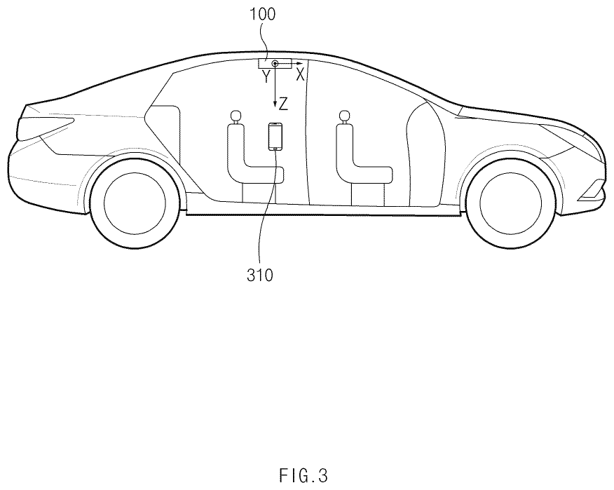

The storage 10 may store various logic, algorithms, and programs required in the processes of detecting the location of the portable terminal inside the vehicle and locating the wireless power transmitter 100 mounted on the roof of the vehicle on a vertical line together with the portable terminal as shown in FIG. 3.

The storage 10 may store various logic, algorithms, and programs required in the processes of detecting the location of the portable terminal inside the vehicle based on an ultra-wideband (UWB) communication scheme and adjusting the location of the wireless power transmitter 100 mounted on the roof of the vehicle.

The storage 10 may store various logic, algorithms, and programs required in the processes of detecting locations of a plurality of portable terminals, determining a portable terminal with a lowest remaining battery level among the plurality of portable terminals as a target portable terminal, and adjusting the location of the wireless power transmitter 100 mounted on the roof of the vehicle based on the location of the target portable terminal.

The storage 10 may store various logic, algorithms, and programs required in the processes of periodically detecting the location of the portable terminal inside the vehicle and periodically adjusting the location of the wireless power transmitter 100 mounted on the roof of the vehicle based on the location of the portable terminal.

The communication device 20 may be a module for providing a communication interface with the portable terminal located inside the vehicle and may receive remaining battery information from the portable terminal. The communication device 20 may include at least one of a mobile communication module, a wireless Internet module, or a short-range communication module.

The mobile communication module may communicate with a portable terminal through a mobile communication network constructed according to a technical standard or communication scheme for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), and the like).

The wireless Internet module, which is a module for wireless Internet access, may communicate with a portable terminal through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may support short-range communication with a portable terminal by using at least one of Bluetooth™, radio frequency identification (RFID), infrared data association (IrDA), ultra wideband (UWB), ZigBee, near field communication (NFC), and wireless universal serial bus (USB) technology.

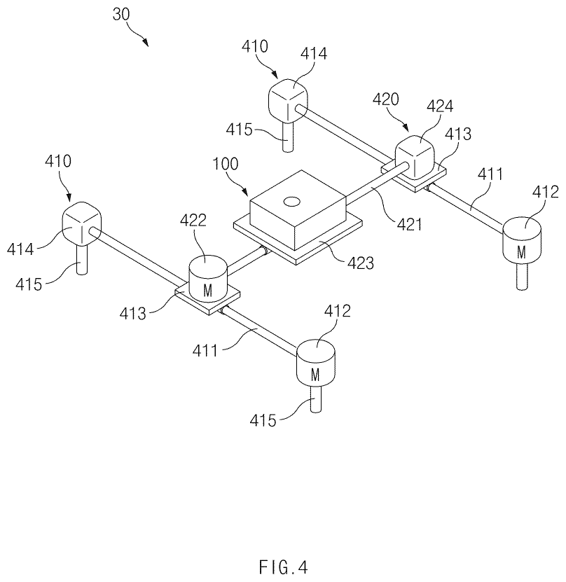

The transfer device 30 may move the wireless power transmitter 100 mounted on the roof of the vehicle in the forward, backward, left, and right directions. The transfer device 30 may be implemented, for example, in a structure shown in FIG. 4.

FIG. 4 is a diagram illustrating an example of the structure of a transfer device provided in an apparatus for controlling charging for a wireless charging system according to an embodiment of the present disclosure.

As shown in FIG. 4, the transfer device 30 to which a ball screw scheme is applied may include an x-axis transfer device 410 and a y-axis transfer device 420. In this case, the x-axis transfer device 410 is configured to move the wireless power transmitter 100 in a longitudinal direction (front and rear directions of the vehicle), and the y-axis transfer device 420 is configured to move the wireless power transmitter 100 in a width direction (left and right directions of the vehicle).

First, the x-axis transfer device 410 may include a first guide bar 411, a first motor 412, a first plate 413, a first fixing device 414, and a support device 415.

The first guide bar 411 is configured to guide the wireless power transmitter 100 in the longitudinal direction. In other words, the wireless power transmitter 100 may be selectively moved in the longitudinal direction along the first guide bar 411.

A thread-shaped ball insertion groove through which a ball is guided is formed in the first guide bar 411. In other words, the first plate 413 may be coupled to the first guide bar 411 with a plurality of balls in contact. When the first guide bar 411 rotates, the first plate 413 may be selectively moved in the longitudinal direction of the first guide bar 411. In this case, the first plate 413 forming a pair is configured to support and fix a second motor 422 and a second fixing device 424, respectively.

The first motor 412 is coupled to one end of the first guide bar 411 and selectively rotates the first guide bar 411.

For example, when the first motor 412 rotates in a forward direction, the wireless power transmitter 100 may be moved toward the first motor 412. To the contrary, when the first motor 412 rotates in a reverse direction, the wireless power transmitter 100 may be moved to the first fixing device 414. As described above, the wireless power transmitter 100 may be selectively moved along the first guide bar 411 in the rotation direction of the first motor 412.

The first fixing device 414 is provided on an opposite end of the first guide bar 411 and is configured to stably support the first guide bar 411. The first fixing device 414 may be a bearing.

The support device 415 is configured to support the first motor 412 and the first fixing device 414. The support device 415 may be fixedly installed on the roof of the vehicle.

The x-axis transfer device 410 is provided in the form of a pair spaced apart and is configured to support the y-axis transfer device 420.

Next, the y-axis transfer device 420 may include a second guide bar 421, the second motor 422, a second plate 423, and the second fixing device 424.

The second guide bar 421 is configured to guide the wireless power transmitter 100 in the width direction. In other words, the wireless power transmitter 100 may be selectively moved in the width direction along the second guide bar 421.

A thread-shaped ball insertion groove through which a ball is guided is formed in the second guide bar 421. In other words, the second plate 423 is coupled to the second guide bar 421 with a plurality of balls in contact. When the second guide bar 421 rotates, the second plate 423 may be selectively moved in the width direction of the second guide bar 421. The wireless power transmitter 100 is placed on and fixed to the second plate 423.

The second motor 422 is coupled to one end of the second guide bar 421 and selectively rotates the second guide bar 421.

For example, when the second motor 422 rotates in the forward direction, the wireless power transmitter 100 may be moved toward the second motor 422. To the contrary, when the second motor 422 rotates in the reverse direction, the wireless power transmitter 100 may be moved to the second fixing device 424.

As described above, the wireless power transmitter 100 may be selectively moved along the second guide bar 421 in the rotation direction of the second motor 422.

The second fixing device 424 is provided on an opposite end of the second guide bar 421 and is configured to stably support the second guide bar 421. The second fixing device 424 may be a bearing.

In this case, the second motor 422 and the second fixing device 424 are placed on, supported by, and fixed to the first plate 413, respectively. Accordingly, a transfer device 30 may improve the charging efficiency of the wireless charging system by selectively moving the wireless power transmitter 100 in the longitudinal and width directions on a two-dimensional plane.

The controller 40 may be electrically connected to each component and may perform overall control such that each component performs its function. The controller 40 may be implemented in the form of hardware or software or may be implemented in a combination of hardware and software. Desirably, the controller 40 may be implemented as a microprocessor but is not limited thereto.

The controller 40 may detect the location of the portable terminal inside the vehicle and may adjust the location of the wireless power transmitter 100 mounted on the roof of the vehicle based on the location of the portable terminal. In this case, as shown in FIG. 3, the controller 40 may position the wireless power transmitter 100 on a vertical line (on the z-axis) with a portable terminal 310. In other words, the controller 40 may control the transfer device 30 to position the wireless power transmitter 100 on the vertical line with the portable terminal 310.

In addition, the controller 40 may detect the location of the portable terminal inside the vehicle based on the UWB communication scheme. In other words, the controller 40 may calculate the exact location of the portable terminal based on the flight time of a frequency signal transmitted and received during UWB communication with the portable terminal. This is similar to Bluetooth but is much more stable due to its wide frequency band.

In addition, when the locations of a plurality of portable terminals inside the vehicle are detected, the controller 40 may determine the portable terminal with the lowest remaining battery power among the plurality of portable terminals as the target portable terminal and may adjust the location of the wireless power transmitter 100 based on the location of the target portable terminal. In this case, the controller 40 may determine the portable terminal detected first inside the vehicle as the target portable terminal.

In addition, the controller 40 may periodically detect the location of the portable terminal inside the vehicle and may periodically adjust the location of the wireless power transmitter 100 based on the location of the portable terminal.

For example, the controller 40 may detect the locations of the plurality of portable terminals inside the vehicle at a period of 30 seconds. When the difference between the current location and the previous location of the target portable terminal among the portable terminals exceeds 200 mm, the controller 40 may adjust the location of the target portable terminal again. In this case, the controller 40 may start charging the target portable terminal when the remaining battery capacity of the target portable terminal is less than 90%. Then, the controller 40 may determine whether the remaining battery capacity of the portable terminal exceeds 98% at a charging time period of 10 minutes. When the remaining battery capacity of the portable terminal exceeds 98%, the controller 40 may terminate charging of the target portable terminal and may determine a new target portable terminal.

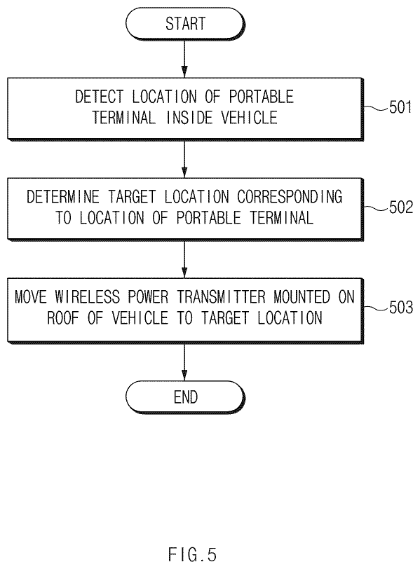

FIG. 5 is a flowchart illustrating a method of controlling charging for a wireless charging system according to an embodiment of the present disclosure.

First, the controller 40 detects the location of the portable terminal inside the vehicle in 501.

Then, in 502, the controller 40 determines the target location corresponding to the location of the portable terminal.

Then, in 503, the transfer device 30 moves the wireless power transmitter 100 mounted on the roof of the vehicle to the target location under control of the controller 40.

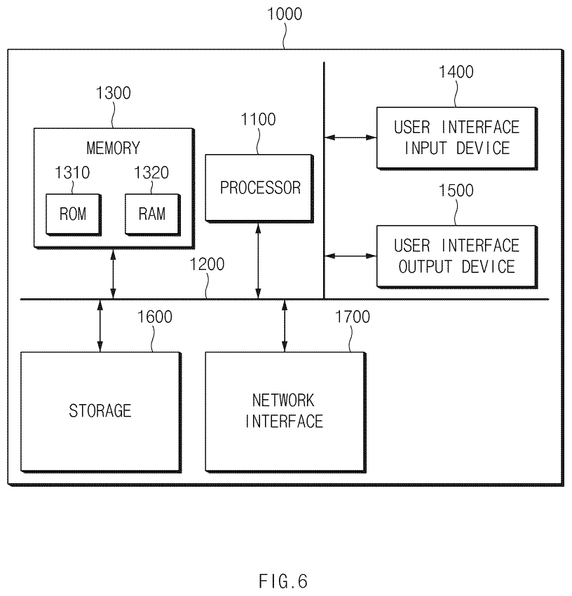

FIG. 6 is a block diagram illustrating a computing system for executing a method of controlling charging for a wireless charging system according to each embodiment of the present disclosure.

Referring to FIG. 6, a method of controlling charging for a wireless charging system according to an embodiment of the present disclosure described above may be implemented through a computing system 1000. The computing system 1000 may include at least one processor 1100, a memory 1300, a user interface input device 1400, a user interface output device 1500, a storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, solid state drive (SSD), a detachable disk, or a CD-ROM. The storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the embodiments of the present disclosure, the apparatus for controlling charging may include a transfer device for moving a wireless power transmitter mounted on a roof of a vehicle in front, rear, left, and right directions. The apparatus may detect the location of a portable terminal inside the vehicle. The apparatus may adjust the location of the wireless power transmitter based on the location of the portable terminal. Thus, the charging efficiency of the wireless charging system mounted on the vehicle may be improved. The present disclosure also provides a method thereof.

Although embodiments of the present disclosure have been described for illustrative purposes, those having ordinary skill in the art should appreciate that various modifications, additions, and substitutions are possible, without departing from the scope and spirit of the disclosure. Therefore, the embodiments disclosed in the present disclosure are provided for the sake of description and are not intended to limit the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the protection scope of the present disclosure.

What is claimed is:

1. An apparatus for controlling charging for a wireless charging system, the apparatus comprising:
a wireless power transmitter mounted on a roof of a vehicle;
a transfer device configured to move the wireless power transmitter in front, rear, left, and right directions; and
a controller configured to
detect a location of a portable terminal inside the vehicle,
determine a target location corresponding to the location of the portable terminal, and
control the transfer device to move the wireless power transmitter to the target location.

2. The apparatus of claim 1, wherein the controller is further configured to determine the target location to allow the wireless power transmitter and the portable terminal to be located on a vertical line.

3. The apparatus of claim 1, wherein the controller is further configured to detect the location of the portable terminal inside the vehicle based on an ultra-wideband (UWB) communication scheme.

4. The apparatus of claim 1, wherein the controller is further configured to determine a portable terminal with a lowest remaining battery level among a plurality of portable terminals as a target portable terminal when the plurality of portable terminals is detected inside the vehicle.

5. The apparatus of claim 4, wherein the controller is further configured to determine a portable terminal with a second lowest battery level as a next target portable terminal when charging of the target portable terminal is completed.

6. The apparatus of claim 1, wherein the controller is further configured to determine a portable terminal detected first among a plurality of portable terminals as a target portable terminal when the plurality of portable terminals is detected inside the vehicle.

7. The apparatus of claim 6, wherein the controller is further configured to determine a portable terminal detected second among the plurality of portable terminals as a next target portable terminal when charging of the target portable terminal is completed.

8. The apparatus of claim 1, wherein the controller is further configured to periodically detect the location of the portable terminal inside the vehicle and re-determine the target location of the wireless power transmitter when a difference between a current location and a previous location of the portable terminal exceeds a threshold.

9. A method of controlling charging for a wireless charging system, the method comprising:
detecting, by a controller, a location of a portable terminal inside a vehicle;
determining, by the controller, a target location corresponding to the location of the portable terminal; and
moving, by a transfer device, a wireless power transmitter mounted on a roof of the vehicle.

10. The method of claim 9, wherein determining the target location includes determining, by the controller, the target location to allow the wireless power transmitter and the portable terminal to be located on a vertical line.

11. The method of claim 9, wherein detecting the location of the portable terminal includes detecting the location of the portable terminal inside the vehicle based on an ultra-wideband (UWB) communication scheme.

12. The method of claim 9, wherein determining the target location includes determining a portable terminal with a lowest remaining battery level among a plurality of portable terminals as a target portable terminal when the plurality of portable terminals is detected inside the vehicle.

13. The method of claim 12, wherein determining the target location further includes determining, by the controller, a portable terminal with a second lowest battery level as a next target portable terminal when charging of the target portable terminal is completed.

14. The method of claim 9, wherein determining the target location includes determining, by the controller, a portable terminal detected first among a plurality of portable terminals as a target portable terminal when the plurality of portable terminals is detected inside the vehicle.

15. The method of claim 14, wherein determining the target location further includes determining, by the controller, a portable terminal detected second among the plurality of portable terminals as a next target portable terminal when charging of the target portable terminal is completed.

16. The method of claim 9, wherein determining the target location further includes:
periodically detecting, by the controller, the location of the portable terminal inside the vehicle; and
re-determining, by the controller, the target location of the wireless power transmitter when a difference between a current location and a previous location of the portable terminal exceeds a threshold.
